(19) United States
(12) Patent Application Publication
(10) Pub. No.: US 2013/0192062 A1
(43) Pub. Date: Aug. 1, 2013

(54) METHOD AND A DEVICE FOR BONDING WIRES TO A SUBSTRATE, IN PARTICULAR BY LASER

(71) Applicant: JFP MICROTECHNIC, Marcoussis (FR)

(72) Inventors: Jean-Baptiste PALOMARES, Cezy (FR); Francois PALOMARES, Buc (FR)

(73) Assignee: JFP MICROTECHNIC, Marcoussis (FR)

(21) Appl. No.: 13/744,748

(22) Filed: Jan. 18, 2013

(30) Foreign Application Priority Data
Jan. 26, 2012 (FR) 12/00230

(51) Int. Cl. B23K 31/02; B23K 26/20

(52) U.S. Cl. CPC B23K 31/02; B23K 26/20
USPC 29/825; 228/4.5; 219/56.1

(57) ABSTRACT

Disclosed are devices for making a bond between a wire and a substrate at a point, and to methods of making the bond. The device includes in particular a pressure foot, a base for supporting the substrate, a delivery source for delivering the wire, the pressure foot being suitable for occupying at least two positions that are respectively closer to and further from the base, the wire delivered by the source being suitable for passing between the pressure foot and the base, a presser finger suitable for occupying two positions respectively closer to and further from the base, an element for mounting the pressure foot and the presser finger to co-operate with the base in such a manner that they define between them a bonding space containing the point, and spot-bonding element suitable for acting at the point.

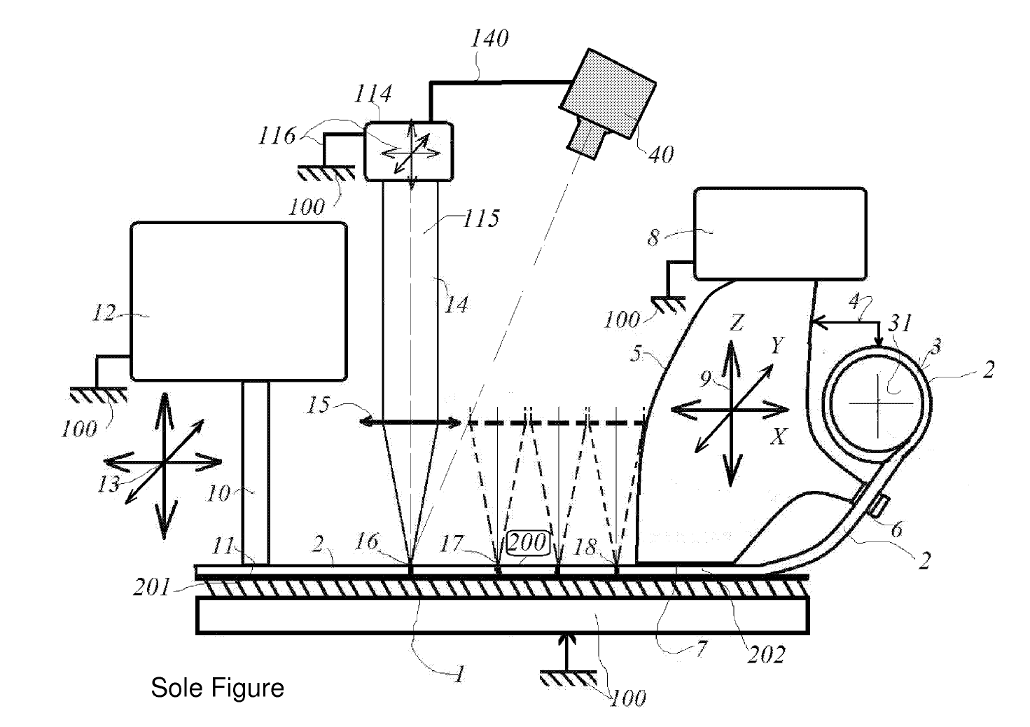

### FIELD OF THE INVENTION

The present invention relates to bonding methods and devices, in particular using a laser or the like, for bonding wires, strips, etc. to a substrate or the like in order to make electrical connections, e.g. in medical appliances or the like such as pacemakers, and it finds a particularly advantageous application for mounting components at the ends of a plurality of wires, e.g. such as on a catheter.

### BACKGROUND OF THE INVENTION

Devices and methods are already known, in particular in microelectronics, for using ultrasound, thermal compression, etc. to bond wires, strips, etc. to a substrate or the like in order to make electrical connections. By way of example, such bonding techniques are described in U.S. Pat. No. 5,148,959 and EP-A-1 226 000, and more particularly in U.S. Pat. No. 7,872,208.

The methods and devices in those documents give good results but they present certain drawbacks, in particular they are relatively complex, both in terms of fabricating the devices and in terms of implementing the methods, and they are only really adapted to making one bond at a time under conditions that are quite restrictive concerning materials compatibility.

### SUMMARY OF THE INVENTION

An object of the present invention is thus to provide a device for mitigating to a large extent the drawbacks of similar devices in the prior art.

More precisely, the present invention provides a method of making a bond by thermal fusion between a wire and a substrate at at least a first point and a second point, the method being characterized in that, after positioning said wire on said substrate, it consists:
in holding a first portion and a second portion of the wire relative to said substrate, these two portions being situated beyond said first point and said second point;
in making a bond at said first point;
in making a bond at said second point after the bond at said first point has been made; and
while the bond at said second point is still in a pasty phase, in exerting a traction force on the second wire portion that is adjacent to said second point, so as to cause said wire to break.

The present invention also provides a device for making a bond by thermal fusion between a wire and a substrate at at least one point, the device comprising:
a pressure foot;
a base, said base being suitable for supporting said substrate;
a delivery source suitable for delivering said wire;
means for mounting said pressure foot to co-operate with said base in such a manner as to be suitable for occupying at least two positions that are respectively closer to and further from the base;
means for associating said delivery source with said pressure foot so that after the wire has been delivered by said delivery source it is suitable for passing between the pressure foot and said base;
a presser finger;
means for mounting said presser finger to co-operate with said base in such a manner as to be suitable for occupying two positions that are respectively closer to and further from the base;
means for mounting said pressure foot and said presser finger to co-operate with said base in such a manner that they define between them a bonding space containing said point; and
spot-bonding means suitable for acting at said point.

### BRIEF DESCRIPTION OF THE DRAWING

Other characteristics and advantages of the present invention appear from the following description given with reference to the purely illustrative and non-limiting accompanying drawing, in which:

the sole figure is a block diagram of an embodiment of the device of the invention suitable for making a bond by thermal fusion between a wire and a substrate at at least one point.

### DETAILED DESCRIPTION OF THE INVENTION

The present invention relates to a method of making a bond by thermal fusion between a wire 2 and a substrate 1 at at least two points, namely a first point 16 and a second point 18, which method has a particularly advantageous application in the medical field for bonding output connections of pacemakers, and mounting components at the end of a plurality of wires, e.g. on a catheter.

With reference to the sole figure, after the wire has been positioned on a substrate 1, the method consists in holding it relative to the substrate in a first portion 201 and in a second portion 202, these two portions 201 and 202 being situated beyond the first point and second point 16 and 18 (i.e. not between them).

Thereafter, with the two portions 201 and 202 still being held, the method consists initially in making a bond at the first point 16 and then in making a bond at the second point 18 after the bond has been made at the first point.

Thereafter, while the bond at this second point is still in a pasty phase, the method consists in exerting a traction force on the second wire portion 202 that is adjacent to the second point 18, so as to break the wire at this point, i.e. substantially at the separation surface between the hard surface of the wire of the second portion 202 and the surface of the pasty mass of the bond. As a result, the portion of the wire situated at the second point 18 does indeed remain bonded to the substrate as soon as the pasty mass solidifies, without there being any need subsequently to cut off the wire at this second bond, where such cutting off is a technical operation that is very difficult to perform, given the very small dimensions of the bonds and the wires that are used, in particular in the field of pacemakers, for example.

In a preferred implementation, when the number of bonds is equal to two as explained more particularly above, the method consists in exerting the traction force on the second wire portion 202 while the first wire portion 201 is still being held.

In the above-described implementation, if the number of points where bonds are to be made is greater than two, the first and second points are the points that are furthest apart in the succession of bonds. With reference to the sole figure, these are the points referenced 16 and 18, there being intermediate points 17, . . . .

Thus, with a plurality of bonding points as mentioned above, the plurality being not less than three, the method consists, once the three bonds have been made at three distinct points 16, 17, and 18 have been made and while the last bond, i.e. the third, is still in a pasty state, in exerting a traction force on the second wire portion 202 that is adjacent to the point 18 where the last bond was made. This traction force is exerted so as to break the wire 2 at this point, with the first wire portion 201 then optionally still being held. Under such circumstances, it might not be necessary to hold the first wire portion 201 since the preceding bonds at the points 16 and 17 can become sufficiently strong and solidified to suffice in themselves to hold the wire portion situated between the first bonding point 16 and the last point 18.

With reference to the sole figure, the present invention also provides a device for using thermal fusion to bond a wire 2 and a substrate 1 at at least one point 16, 17, 18, . . . .

The device has a pressure foot 5, a base 100 suitable for supporting the substrate 1, a delivery source 3 suitable for delivering the wire 2, means 8, 9 for mounting the pressure foot 5 to co-operate with the base 100 in such a manner as to be suitable for occupying at least a first position and a second position, which positions are respectively closer to and further from the base.

With reference to the accompanying figure, the pressure foot may thus move relative to the base in the direction referenced Z in an X, Y, and Z reference frame 9. If the wire has a thickness E and the substrate has a thickness H, then the first position is defined as follows:

i) if the substrate is arranged between the pressure foot 5 and the base 100, the distance between the pressure foot and the base is determined so as to be at least less than E+H (as shown); and

ii) if the substrate is not arranged between the pressure foot 5 and the base 100, the distance between the pressure foot and the base is determined so as to be at least less than E.

The means 8, 9 for mounting the pressure foot 5 to co-operate with the base 100 in such a manner as to be suitable for occupying at least a first point and a second point that are respectively closer to and further from the base are themselves well known to the person skilled in the art in this field. They may be of the type involving a slideway or a rack or the like, and they are not described in greater detail herein.

The device also has means 4 for associating the delivery source 3 with the pressure foot 5 so that after the wire 2 has been delivered by the delivery source 3, it is suitable for passing between the pressure foot and the base 100 so as to be subsequently unreeled onto the substrate 1 and cover at least the intended bonding points 16-18, and also over an additional distance, as shown in the sole figure.

A presser finger 10 is also provided, together with means 12, 13 for mounting the presser finger 10 to co-operate with the base 100 in such a manner as to be suitable for occupying two positions, respectively closer to and further from the base. These two positions have the same values as those defined above for the movement of the pressure foot 5, or values that are similar.

The means 12, 13 may be of the same type as those defined above for the means 8, 9.

In addition, the device has means for mounting the pressure foot 5 and the presser finger 10 to co-operate with the base 100 in such a manner as to define between them a bonding space 200 over a certain length containing the point 16, 17, 18, and spot-bonding means 14 suitable for acting at the point.

It is also most advantageous for the device also to have means for moving the pressure foot 5 and the presser finger 10 relative to each other, optionally the presser finger towards the pressure foot, along the X directions in the reference frames 9, 13 in order to adjust the length of the bonding space as a function of the number of bond points to be made, thereby avoiding having excessive lengths for the wire portions 201, 202 situated beyond the first point 16 and the last point 18 in the sole figure.

Means may be provided for moving the pressure foot 5 and the presser finger 10 in the Y direction in the reference frames X, Y, Z.

The above-defined means for imparting X, Y, Z movement to the pressure foot 5 and to the presser finger 10 may be combined to obtain all of the functions that are allocated thereto. These combined means may for example be of the same type as those defined above, i.e. a combination of slideways and/or racks. Their various possible embodiments are likewise well known to the person skilled in the art and there is no need to describe them in greater detail.

Preferably, the means 4 for associating the delivery source 3 with the pressure foot 5 include at least one groove 6 formed in the pressure foot 5, this groove being arranged in such a manner as to guide the wire after it has been delivered by the delivery source 3 so that it passes between the pressure foot and the base without being distorted.

By way of example, the delivery source 3 may be constituted by a reel 31 on which the wire 2 is reeled, the reel 31 being arranged in such a manner that after the wire has been unreeled from the reel 31 it passes without being distorted into the groove 6, and specifically the reel may be mounted to rotate about an axis that is tied to the pressure foot 5.

In one possibility that may present advantages in certain circumstances for exerting the traction force, means may also be provided for moving the pressure foot at least along the direction X in the X, Y, Z reference frame 9 as shown in the accompanying figure for the purpose of moving the pressure foot 5 away from the last point 18, and/or means may also be provided for preventing the reel 31 from turning, and/or means may also be provided for causing the reel to turn in the direction for reeling in the wire 2, and/or means may be provided for moving the reel in the above-defined X direction.

It is also specified that these means may be automatic, or semi-automatic, or even manual.

With a device of structure as described above, and in particular for the applications mentioned initially, it is most advantageous for the spot bond 14 to be made by means of a laser generator 114, advantageously a yttrium aluminum garnet (YAG) laser that is suitable for delivering a beam of energy along an outlet optical axis 115, means 116 for mounting the laser generator 114 so that it co-operates with the base 100 in such a manner that the optical axis 115 is directed towards the bonding space 200, and means 15, such as a converging lens or the like shown diagrammatically in the figure, for focusing the energy beam of the point 16, 17, 18.

In order to be able to make a plurality of bonds in the bonding space 200, it is entirely preferable for the above-defined means 116 for mounting the laser generator 114 to co-operate with the base 100 to be constituted by means for moving the laser generator in at least one of the three non-coincident directions X, Y, Z associated with the base 100 and advantageously constituting the reference frame associated with the device. In conventional manner, these three directions may be mutually orthogonal, as in the Galilean frame of reference.

These means 116 for mounting the laser generator 114 to co-operate with the base 100 are of the same type as the means referenced 8, 9 and/or 12, 13, and once more they are not described in detail herein since they are within the competence of the person skilled in the art.

In order to facilitate the work of users of such a device, it is entirely advantageous for the device also to include a camera 40 and means 140 for mounting the camera in association with the laser generator 114 so as to view the point 16, 17, 18, it being specified that the camera provides very considerable magnification.

A management member (not shown), which may be of the programmable microprocessor or like type, may also be provided and be connected to all of the controllable means, such as those for moving the pressure foot 5, the presser finger 10, the laser generator 114, the camera 40, and/or those for unreeling or braking the unreeling of the reel 31.

Such a processor member may enable the device of the invention to operate in at least semi-automatic manner.

Since it does not come within the ambit of the present invention, it is not described in greater detail herein, in order to simplify the present description.

The way in which the device of the invention operates and is used can be seen clearly from reading the above two descriptions of the implementation of the method and the structure of the device.

Nevertheless, it is specified that the traction force applied to the second wire portion 202 may be obtained, where appropriate, manually or semi-automatically, e.g. by preventing the reel 31 from unreeling, and then reversing the pressure foot 5, or else reeling in the wire onto the reel, while leaving the pressure foot stationary, after moving it into its second position, etc.

1. A method of making a bond by thermal fusion between a wire and a substrate at at least a first point and a second point, the method consisting, after positioning said wire on said substrate:
in holding a first portion and a second portion of the wire relative to said substrate, these two portions being situated beyond said first point and said second point;
in making a bond at said first point;
in making a bond at said second point after the bond at said first point has been made; and
while the bond at said second point is still in a pasty phase, in exerting a traction force on the second wire portion that is adjacent to said second point so as to cause said wire to break.

2. A method according to claim 1, further consisting in exerting said traction force on the second wire portion while the first wire portion is still being held.

3. A method according to claim 1, which consists, when at least three bonds are made at three distinct points, in exerting a traction force on the second wire portion that is adjacent to the point at which the last bond has been made until the wire breaks at said point, the first wire portion optionally being held while said traction force is being exerted.

4. A device for making a bond by thermal fusion between a wire and a substrate at at least one point, the device comprising:
a pressure foot;
a base, said base being suitable for supporting said substrate;
a delivery source suitable for delivering said wire;
means for mounting said pressure foot to co-operate with said base in such a manner as to be suitable for occupying at least two positions that are respectively closer to and further from the base;
means for associating said delivery source with said pressure foot so that after the wire has been delivered by said delivery source it is suitable for passing between the pressure foot and said base;
a presser finger;
means for mounting said presser finger to co-operate with said base in such a manner as to be suitable for occupying two positions that are respectively closer to and further from the base;
means for mounting said pressure foot and said presser finger to co-operate with said base in such a manner that they define between them a bonding space containing said point; and
spot-bonding means suitable for acting at said point.

5. A device according to claim 4, wherein the means for associating said delivery source with said pressure foot include at least one groove formed in said pressure foot, the groove being arranged in such a manner as to guide said wire after it has been delivered by said delivery source so that it passes between the pressure foot and the base.

6. A device according to claim 4, wherein the spot-bonding means are constituted by a laser generator suitable for delivering an energy beam along an outlet optical axis, means for mounting said laser generator to co-operate with said base in such a manner that the optical axis is directed towards said bonding space, and means for focusing said energy beam on said point.

7. A device according to claim 6, wherein the means for mounting said laser generator to co-operate with said base are constituted by means for moving said laser generator along at least one direction among three non-coinciding directions associated with the base.

8. A device according to claim 6, further including a camera and means for mounting said camera in association with said laser generator so that said camera views said point.

9. A device according to claim 6, wherein said laser generator is an yttrium aluminum garnet (YAG) laser.

10. A device according to claim 4, further including means for moving said pressure foot and said presser finger relative to each other, and optionally from moving the presser finger towards the pressure foot.
